(19) United States
(12) Patent Application Publication
(10) Pub. No.: US 2017/0138092 A1
(43) Pub. Date: May 18, 2017

(54) Modular Lock System

(71) Applicant: CKI LOCKER, LLC, North Las Vegas, NV (US)

(72) Inventors: David Scott Frank, Grapevine, TX (US); Daniel Nohr, Dalls, TX (US); Efrain Rodriguez, Richardson, TX (US)

(73) Assignee: CKI LOCKER, LLC, North Las Vegas, NV (US)

(21) Appl. No.: 15/354,037

(22) Filed: Nov. 17, 2016

Related U.S. Application Data
(60) Provisional application No. 62/256,337, filed on Nov. 17, 2015.

(51) Int. Cl. E05B 65/02; G07F 17/12; E05B 47/00; E05B 37/16; E05B 35/14; E05B 63/00

(52) U.S. Cl. CPC E05B 65/025; E05B 35/14; E05B 63/00; E05B 47/0004; E05B 37/16; G07F 17/12; E05B 2047/0091

(57) ABSTRACT

A modular lock assembly for placement in an opening in a frame of a cabinet locker that is located adjacent to a door of the cabinet locker. The modular lock assembly includes a mounting plate for removeably being positioned in the opening. A locking plate is moveably connected to the mounting plate. An electromechanical actuator is connected to the mounting plate and coupled with the locking plate to automatically provide the movement of the locking plate. An input device is electrically connected to the electromechanical actuator for activating the electromechanical actuator in response to inputs. The mounting plate defines a custodian opening for receiving a custodian lock for locking the mounting plate to the frame. At least one tongue extends from the mounting plate in spaced relationship with the custodian opening for engaging the frame for further securing the mounting plate to the frame.

### CROSS-REFERENCE TO RELATED APPLICATIONS

This U.S. patent claims the benefit of U.S. Provisional Patent Application Ser. No. 62/256,337 filed Nov. 17, 2015, entitled “Modular Lock System,” the entire disclosure of the application being considered part of the disclosure of this application and hereby incorporated by reference.

### TECHNICAL FIELD

A modular lock system for locker systems. More specifically, a modular electronic lock assembly for locking cabinet locker systems, such as rental lockers, and a modular electronic lock system configured to easily replace mechanical or keyed locks, and retain certain functionality while minimizing changes to the existing locker system.

### BACKGROUND OF THE DISCLOSURE

Coin and key operated cabinet locker systems are known in the art for allowing users to securely store items and are commonly seen in train stations, sporting venues, ski slopes gyms, evidence lockers, and any other type of location or facility where it is desired to secure items. An example of such a cabinet locker system 12 is shown in FIGS. 1-3. The system 12 includes a frame 1 that defines a storage compartment 2. The storage compartment 2 may be in all sizes and shapes to store different items. A door 3 is pivotally connected to the frame 1 for opening and closing the storage compartment 2. The frame 1 also defines a slot or opening 4 adjacent to the storage compartment 5 for receiving a lock assembly 6. The lock assembly 6 is adjustable between a locked position for locking the door 3 in a closed position, and an unlocked position for allowing the door 3 to be opened. The lock assembly 6 may include a coin mechanism 7 for unlocking the lock assembly 6 in response to a coin being inserted into a coin slot 8. Other lock assemblies may be configured without the coin mechanism 7. The lock assembly 6 also includes key mechanism 9 for allowing a user to lock the door 3 in response to the rotation of a key 10. The key mechanism 9 includes a locking plate 11 that is positioned to extend into a slit or opening on the cabinet door 3 in response to rotation of the key 10 for preventing the cabinet door 3 from being opened. As such, the lock assembly 6 and frame 1 cooperate to only allow locking of the locker system 12 upon full closure of the door 3 against the frame 1. In addition, some locker systems have a lock assembly 6 that may include a manager function that allows opening of the lock system 6 with a manger or master key, or even easy removal from the locker to allow quick and easily replacement of broken or damaged lock assemblies quickly and easily, and typically without any tools.

Vendors of such locker systems 12 are required to maintain an inventory of keys and also must incur expenses when replacing lost or damaged keys. Recently, electronic locker systems have been developed that incorporate keypads allowing a user to set and enter a personal identification number (PIN) to gain access to a locker. While these electronic locker systems eliminate the need for keys, replacing an existing coin and key operated locker system with a new electronic locker system is not an economically viable alternative for many vendors. More specifically, in retrofitting existing locker systems that are mechanical key operated such as using coins and keys, the solution to date has been to either remove the complete locker system and replace with a whole new electronic locker system, or at a minimum remove the face frames and doors and put on new face frames in doors with built in electronic locks. The removal and replacement option is very time consuming and may require weeks to remove and install a new system. In addition, removal of a perfectly good locker system is not only wasteful, it is expensive, and retrofits that do not require removal allow continued use of the existing locker system until the retrofit is complete. In regards to the replacement of the face frame and doors, as these make up the majority of the locker system and the new face frame has to be specifically designed to exactly match the size and shape of the existing face frame, which may be custom sized, the replacement face frame and doors may be more expensive and time consuming. Therefore, to date the preferred method for providing electronic retrofits of locker systems is the faster option of a complete removal and installation of a completely new system, not utilizing any parts of the prior system.

In addition, many places, such as theme parks, bowling alleys, public stations, ski lodges, and other locations where rental lockers are typically available, moving to an electronic locker system is beneficial due to the additional functionality that it provides. However, the cost of replacement and time required for replacement, and lack of available options for storage for replacement is a big barrier to most places considering replacement.

In view of the foregoing, there is a need for an electronic lock system that can easily be retrofitted onto existing coin and key operated locker systems, with minimal time and expense.

### SUMMARY OF THE INVENTION

According to an aspect of the disclosure, a modular lock assembly is provided for placement in an opening in a frame of a locker that is located adjacent to a door of the locker. The modular lock assembly includes a mounting plate for removeably being positioned in the opening and configured to be selectively secured to the frame. The mounting plate is generally configured to fit in the opening and has a similar size and shape to the mounting plate for any mechanical lock it replaces. A locking plate is moveably connected to the mounting plate and moveable between a locked position for engaging the door to prevent the door from opening, and an unlocked or retracted position for being withdrawn from engagement with the door to allow the door to open freely. An electromechanical actuator is coupled to the mounting plate and further coupled to the locking plate to provide movement of the locking plate between the locked position and the unlocked position. An input device is electrically connected to the electromechanical actuator for activating the electromechanical actuator in response to inputs received. The mounting plate defines a custodian opening for receiving a custodian lock for locking the mounting plate to the frame. At least one tongue extends from the mounting plate in spaced relationship with the custodian opening for engaging the frame for further securing the mounting plate to the frame.

According to another aspect of the disclosure, a locker is provided. The locker includes a frame defining a storage compartment. A door is pivotally connected to the frame and is moveable to open and close the storage compartment. The frame defines an opening adjacent to the storage compartment. A modular lock assembly is removeably received in the opening and is configured to be selectively secured to the frame. The modular lock assembly includes a mounting plate removeably disposed in the opening. At least one tongue extends from the mounting plate and engages the frame for securing the mounting plate to the frame. A locking plate is moveably connected to the mounting plate and moveable between a locked position engaging the door to prevent the door from opening, and an unlocked position being spaced from the door to allow the door to open. An electromechanical actuator is coupled to the mounting plate and is further coupled to the locking plate to automatically provide the movement of the locking plate between the locked position and the unlocked position. An input device is electrically connected to the electromechanical actuator for activating the electromechanical actuator in response to inputs received. The mounting plate defines a custodian opening in spaced relationship with the at least one tongue for receiving a custodian lock for locking the mounting plate to the frame.

According to yet another aspect of the disclosure, the electromechanical actuator includes a solenoid and a bolt coupled to the solenoid and the locking plate. The bolt is moveable to provide the movement of the locking plate between the locked and unlocked positions. A biasing member is coupled with the bolt and biases the bolt in an extended bolt position which positions the locking plate in the locked position.

According to yet another aspect of the disclosure, the bolt is moveable between the extended position and a retracted position. More particularly, the bolt is configured to move to the retracted position in response to activation of the solenoid, which also moves the locking plate to the unlocked position. The bolt is configured to move to the locked position when the solenoid is not activated to move the locking plate to the locked position.

According to yet another aspect of the disclosure, the input device is selected from the group consisting of at least one of a keypad positioned on the mounting plate, a Bluetooth receiver, a radio frequency identification receiver, or a near field communication receiver.

According to yet another aspect of the disclosure, the mounting plate has a generally rectangular shape, has an inside surface and an outside surface, and extends between a top edge and bottom edge along a pair of side edges.

According to yet another aspect of the disclosure, the custodian opening is defined adjacent to the top edge, and the at least one tongue extends from the mounting plate adjacent to the bottom edge.

According to yet another aspect of the disclosure, a custodian lock is received by the custodian opening. The custodian lock includes a key slot and a locking tab being rotatable relative to the mounting plate past the top of the mounting plate for engaging the frame to lock the mounting plate to the frame.

According to yet another aspect of the disclosure, the locking plate is coupled with the mounting plate. The locking plate overlies the inside surface of the mounting plate. The locking plate is linearly moveable past one of the sides in perpendicular relationship to the at least one of the sides toward the locked position.

According to yet another aspect of the disclosure, a support member overlies the inside surface of the mounting plate. A pair of guide fingers that have an L-shape extend from the support member and are positioned in spaced and aligned relationship with one another. Each of the guide fingers defines a channel. The locking plate is received by the channels of the guide fingers and is moveable relative to the guide fingers.

According to yet another aspect of the disclosure, the locking plate has an upper surface and a lower surface. A pair of retaining fingers each extend from one of the upper and lower surfaces for engaging one of the guide fingers during movement of the locking plate toward the locked position to limit movement of the locking plate.

According to these and other aspects of the disclosure, the invention therefore provides an electronic modular lock assembly that may easily be retrofitted onto existing coin and key operated locker systems, with minimal time and expense. More specifically, the modular lock assembly is compact and simple in design, and thus may easily be fitted into, and secured to an existing locker system.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front, perspective view of a conventional coin and key operated cabinet locker system;

FIG. 2 is the locker system of FIG. 1 with the lock assembly removed therefrom and the cabinet door in an opened position;

FIG. 3 is a side cutaway view of the lock assembly of the locker system of FIG. 1;

FIG. 4 is a perspective view of an embodiment of a modular electronic lock assembly according to an aspect of the subject disclosure;

FIG. 5 is a front view of the modular electronic lock assembly of FIG. 4;

FIG. 6 is a side view of the modular electronic lock assembly of FIG. 4;

FIG. 7 is a rear view of the modular electronic lock assembly of FIG. 4;

FIG. 8 is a front view of an example embodiment of a modular electronic lock assembly including a plurality of connecting wires in accordance with an aspect of the disclosure;

FIG. 9 is a side view of the modular electronic lock assembly of FIG. 8;

FIG. 10 is a rear view of the modular electronic lock assembly of FIG. 8; and

FIG. 11 is a side view of the modular electronic lock assembly of FIG. 8.

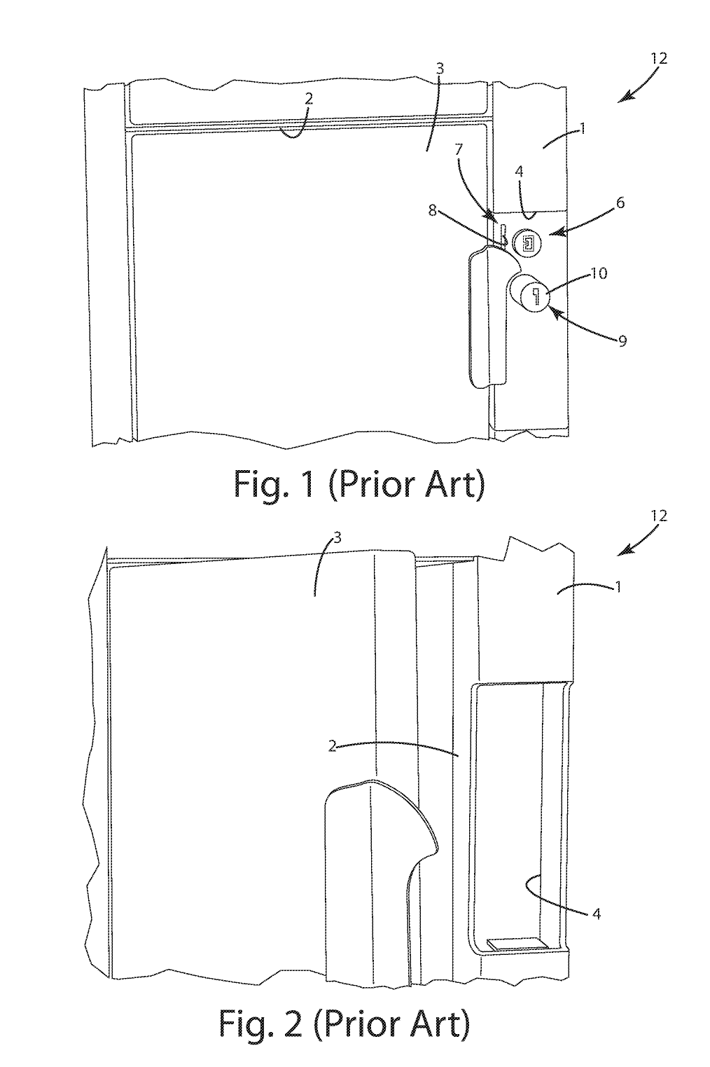

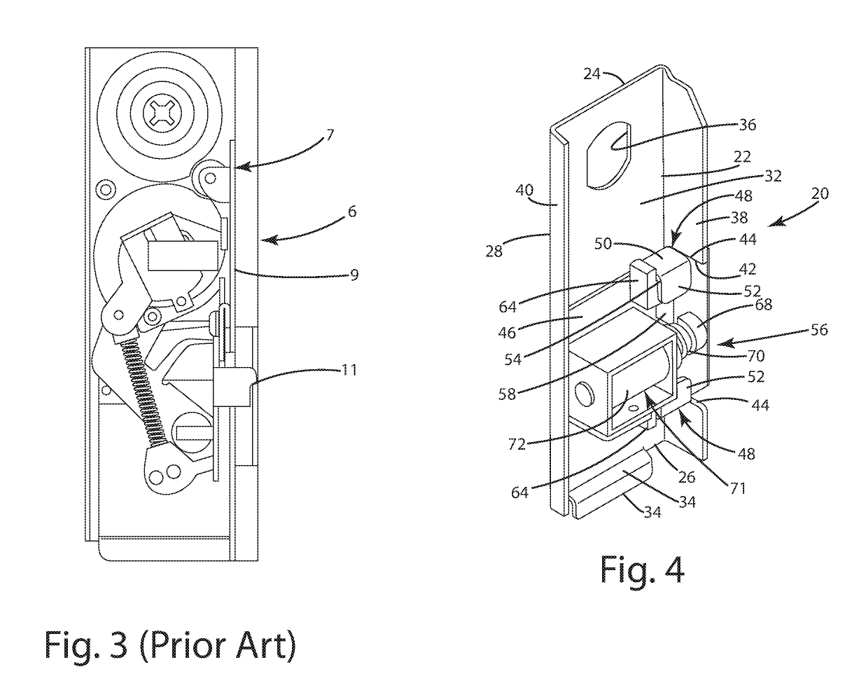

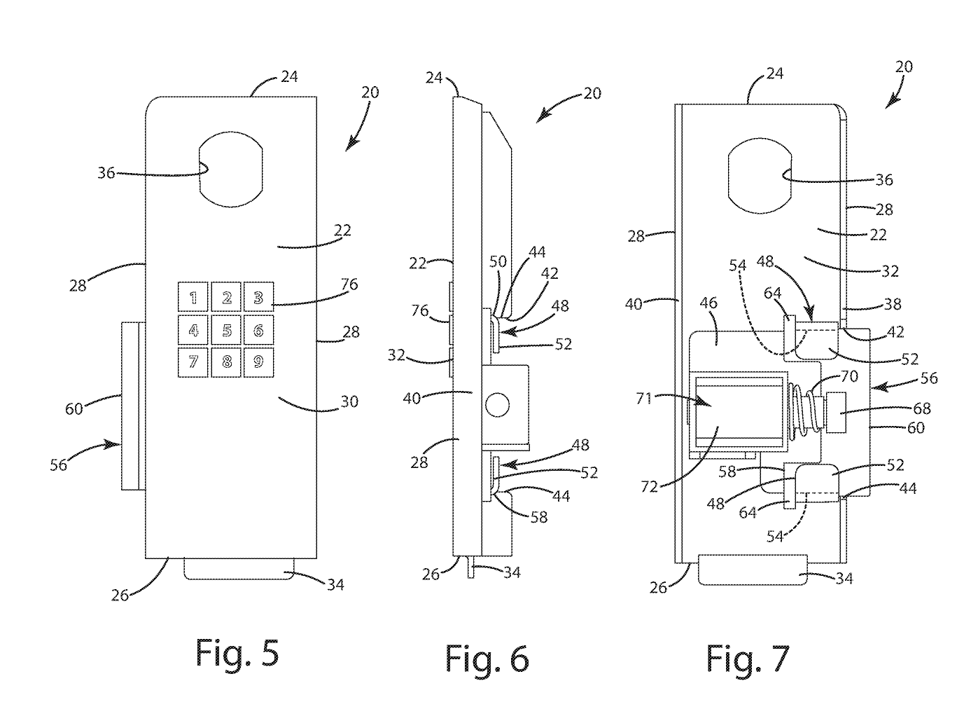

### DESCRIPTION OF THE EXAMPLE EMBODIMENTS

Referring to the Figures, wherein like numerals indicate corresponding parts throughout the several views, a modular electronic lock assembly 20 for a locker system 12 is generally shown for being received by an opening or slot 4 in a frame 1, such as the illustrated face frame, of a cabinet 2.

The modular electronic lock assembly 20 includes a mounting plate 22 that generally extends between a top edge 24 and bottom edge 26 along a pair of side edges 28. The mounting plate 22 of the present invention is generally rectangular shaped, however other shapes could be used, but the mounting plate 22 generally matches the shape of the mounting plate of the removed mechanical lock. The modular lock assembly 20 is generally formed out of modular parts that are easily replaced or substituted to fit other sizes or shapes, or even other functionality. The mounting plate 22 also presents a front face 30 and a back face 32. The lock assembly 20, particularly the mounting plate 22, is generally configured to fit into the opening 4 in the frame 1. The front face 30 is shaped such that when the mounting plate 22 is installed in the opening 4, the front face 30 forms a coextensive front with the frame 1. It should be appreciated that the mounting plate 22 could have various other shapes.

A tongue 34 extends from an edge of the mounting plate 22, such as the bottom edge 26, for engaging the frame 1 for securing the an edge 26 of the mounting plate 22 to the frame 1 when the lock assembly 20 is disposed in the slot 4 of the frame 1. Of course, any other edge may be configured to be secured to the frame 1. More specifically the tongue 34 creates a fixed mounting edge that is secured behind the back surface of the outer portion of the frame 1, such as the illustrated ledge 35 in FIG. 4 on which the mounting plate 22 sits on the edge of the opening 4 on the frame 1, with the rest of the tongue 34 extending behind the back surface of the front portion of the frame 1. In other words, the tongue 34 is offset from the front face 30 (via the ledge 35) of the mounting plate 22 by approximately the thickness of the metal forming the frame 1. While some tolerance is allowed, generally a tight fit is desired to hold the frame 1 and mounting plate 22 in a tight grip with little movement when the key lock is engaged, as described below, such as to prevent noise and improper function of the lock assembly. In addition, the mounting plate 22 includes various flanges or wings 38, 40 on the edges 24, 26, 28. These flanges or wings 38, 40 overlap and engage the frame 1 of the cabinet. Therefore, while the flanges or wings 38, 40 overlap the frame 1 on the sides, the lower ledge and tongue 34 engage the back or opposite side, and as described below, the lock assembly 20 has a custodian lock 37 that rotates to also engage the back side of the frame 1, creating two side members engaging one side of the frame 1 and two other members engaging the other side of the frame 1 for a secure fit within the opening 4. It should be understood that these lock assemblies 20 need to be robust and take substantial abuse as people, particularly in unsupervised locations try to access what is in locked lockers. One advantage of an electronic system is that all of the doors may be locked and it isn't clear which contain goods, as compared to conventional keyed rental lockers that immediately let people know which lockers are in use.

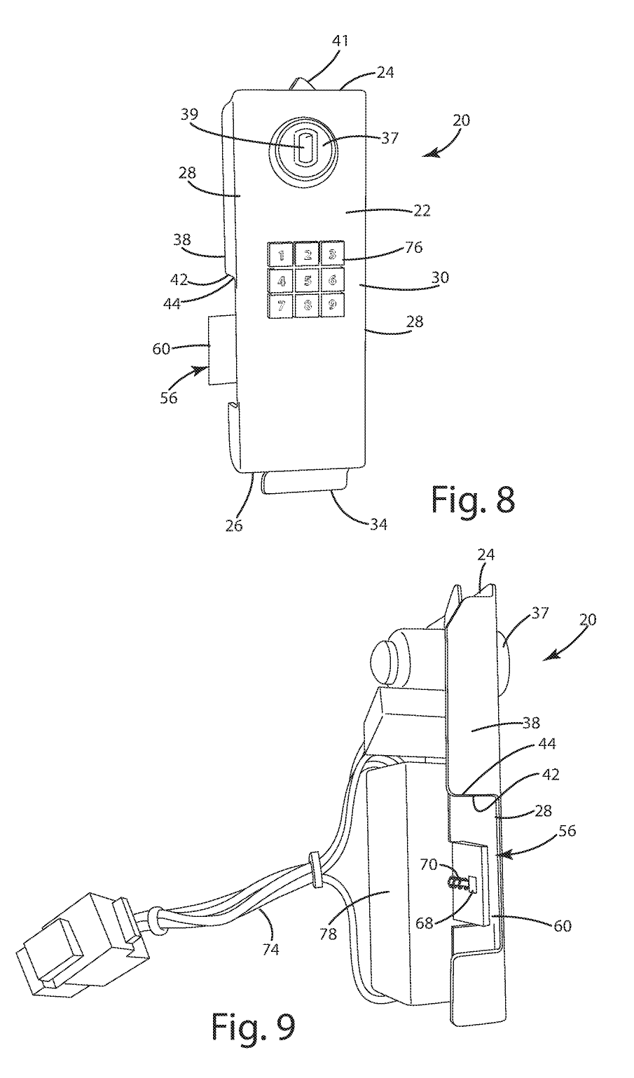

The mounting plate 22 further defines an opening 36 adjacent to the top edge 24 of the mounting plate 22 for receiving the custodian lock 37. The custodian lock 37 releasably secures the top edge 24 of the mounting plate 22 to the frame 1 when the lock assembly 20 is disposed in the slot 4 of the frame 1. More specifically, as best illustrated in FIG. 8, the custodian lock 37 can be adjusted between a locking position that secures the top edge 24 of the mounting plate 22 to the frame and an unlocking position that releases the top edge 24 of the mounting plate 22 from the frame 1 to allow the lock assembly 20 to be removed from the slot 4. The custodian lock 37 may include a key slot 39 and locking tab 41. The locking tab 41 is rotatable between the locking position in which it engages the frame 1, and the unlocking position in which it is spaced from the frame 1. It should be appreciated that the opening 36 and custodian lock 37 could be positioned at other locations, however, they should be spaced from the tongue 34 and flange or wings 38, 40 to provide a locking interface at more than one location of the mounting plate 22.

As discussed above, a first wing or flange 38 and a second wing or flange 40 each extend from one of the side edges 28 of the mounting plate 22 in perpendicular relationship with the mounting plate 22 for aligning the mounting plate 22 inside the slot 4 of the frame 1. The first wing 38 defines a niche 42 that extends between a pair of edges 44.

A generally square-shaped lock member 46 overlies the back face 32 of the mounting plate 22 adjacent to the niche 42. It should be appreciated that the lock member 46 could have other shapes, e.g., a generally oval shape, without departing from the scope of the subject disclosure. A pair of generally L-shaped guide fingers 48 each extend from the lock member 46 adjacent to one of the side edges 28 of the niche 42. Each of the guide fingers 48 includes a first portion 50 that extends perpendicularly to the lock member 46 and a second portion 52 that extends perpendicularly to the first portion 50 with the second portions 52 of the guide fingers 48 extending toward one another to define a channel 54 between the first and second portions 50, 52 of each of the guide fingers 48.

A locking plate 56 overlies the lock member 46 and is received by the channels 54 of the guide fingers 48 and extends between a proximal end 58 and a distal end 60. The locking plate 56 is moveable toward and away from the second wing 40 between a locked position and an unlocked position. In the locked position, the distal end 60 of the locking plate 56 extends through the niche 42 past the first wing 38 for engaging the door 3 for preventing the door 3 from being opened. In the unlocked position, the distal end 60 of the locking plate 56 is spaced from the door 3 to allow the door 3 to be opened. For example, while in the unlocked position, the distal end 60 may be aligned with the side edge 28 of the mounting plate 22. It should be appreciated that the distal end 60 may be received by a slot or other feature of the door 3 to ensure that the distal end 60 fixedly engages the door 3 to ensure that the door 3 is locked in place.

A pair of retaining fingers 64 extend transversely from the proximal end 58 of the locking plate 56, each in alignment with one of the guide fingers 48 for limiting movement of the locking plate 56 away from the second wall. Further, a flange 66 extends transversely from the distal end 60 of the locking plate 56.

An electromechanical actuator 71 is connected to the mounting plate 22 and is coupled with the locking plate 56 to automatically provide the aforementioned movement of the locking plate 56 between the locked and unlocked positions. The electromechanical actuator 71 includes a bolt 68 that is disposed in engagement with the retaining flange 66 and is moveable toward and away from the retaining flange 66 for moving the locking plate 56 between the locked and unlocked positions. More specifically, the bolt 68 is moveable between an extended position and a retracted position. When the bolt 68 is in the extended position, the locking plate 56 is in its locked position, and when the bolt 68 is in its retracted position, the locking plate 56 is in its unlocked position. A biasing member 70 is connected to the bolt 68 for biasing the bolt 68 in its extended position toward the retaining flange 66 to bias the locking plate 56 in the locked position. It should be appreciated that the biasing member 70 may be positioned at various locations, e.g., it may be disposed about the bolt 68 or it may engage a surface of the bolt 68. It should also be appreciated that various types of biasing members may be utilized including, but not limited to, a spring or rubber band. In the example embodiment, the bolt 68 and locking plate 56 are configured to move linearly, however, it should be appreciated that they could be configured to move in other patterns, e.g., in an arc-shape.

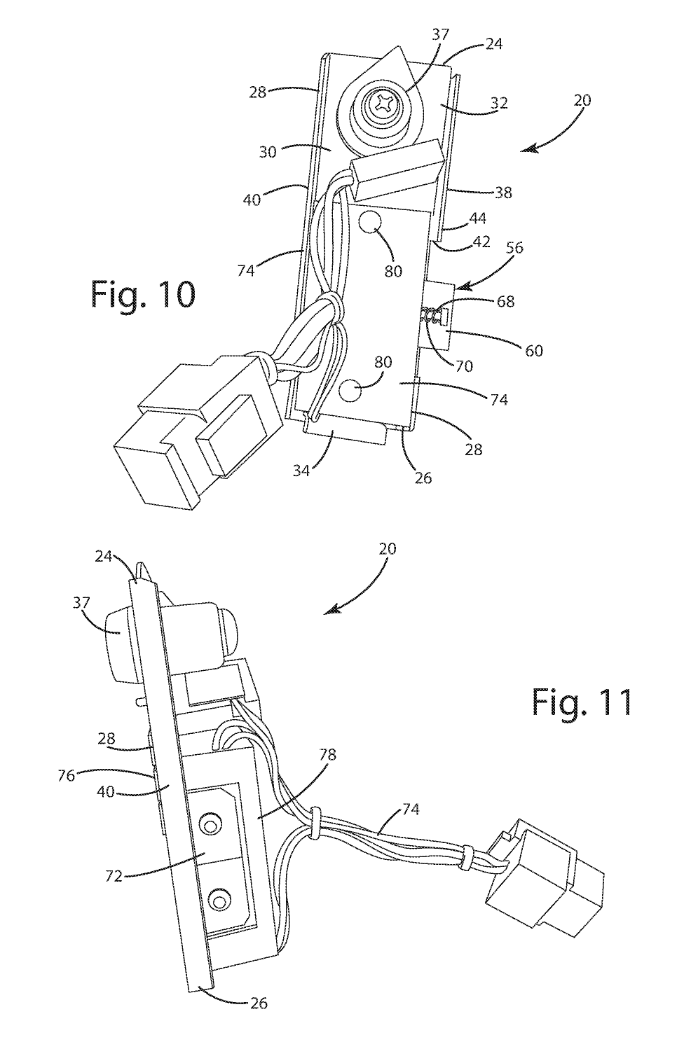

The electromechanical actuator further includes a solenoid, servo, or other electromechanical device 72 (hereinafter referred to as solenoid) that is disposed against the back face 32 of the mounting plate 22 and connected to the bolt 68 for selectively providing the movement of the bolt 68 toward and away from the retaining flange 66. As best illustrated in FIGS. 9-11, a plurality of wires 74 extend away from the solenoid 72 for providing power to the solenoid 72. The wires 74 may also extend to a controller for controlling activation of the solenoid 72 in response to a command that is provided by an input device 76, e.g., a keyboard 76 on the front face 30 of the mounting plate 22 or a remote kiosk. The input device 76 may include other types of input devices including, but not limited to, a Bluetooth receiver, an radio frequency identification (RFID) receiver, or a near field communication (NFC) receiver.

A cover 78 is disposed about the solenoid 72 for protecting the solenoid 72. A pair of fasteners 80 extend though the cover 78 and into the mounting plate 22 for securing the cover 78 to the mounting plate 22. It should be appreciated that any number of fasteners 80 could be utilized and various types of fasteners 80 could be used including, but not limited to, bolts 68, adhesives and screws.

It should be appreciated that the simple, modular design of the lock assembly 20 makes it easy to retrofit the lock assembly 20 onto an existing coin and key operated locker system 12. More specifically, the existing coin and key lock assembly may be removed and the subject lock assembly 20 may easily be installed in its place. The present invention allows simple replacement of a coin operated lock, simply by using a custodial key to remove the mechanical device and insert in place the electronic lock assembly 20 of the present invention. The subject lock assembly 20 may be configured to have a keypad 76 and may be battery powered for independent operation, however, it is expected that the lock assembly 20 will be connected to a controller to allow for smart rental of the lockers. With the subject lock assembly 20 now being so easy to replace, all the remains is the routing of the wires through the channels already formed by the existing frames, back to a controller or kiosk.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A modular lock assembly for placement in an opening in a frame of a locker that is located adjacent to a door of the locker, said modular lock assembly including:
a mounting plate for removeably being positioned in the opening and configured to be selectively secured to the frame;
a locking plate moveably connected to said mounting plate and moveable between a locked position for engaging the door to prevent the door from opening, and an unlocked position for being spaced from the door to allow the door to open;
an electromechanical actuator coupled to said mounting plate and further coupled with said locking plate to automatically provide the movement of said locking plate between said locked position and said unlocked position;
an input device electrically connected to said electromechanical actuator for activating said electromechanical actuator in response to inputs received;
said mounting plate defining a custodian opening for receiving a custodian lock for locking said mounting plate to said frame; and
at least one tongue extending from said mounting plate in spaced relationship with said custodian opening for engaging the frame for further securing said mounting plate to the frame.

2. A modular lock assembly as set forth in claim 1 wherein said electromechanical actuator includes a solenoid and a bolt coupled to said solenoid and said locking plate, wherein said bolt is moveable to provide said movement of said locking plate between said locked and unlocked positions, and wherein a biasing member is coupled with said bolt and biases said bolt in an extended bolt position which positions said locking plate in said locked position.

3. A modular lock assembly as set forth in claim 2 wherein said bolt is moveable between said extended position and a retracted position; wherein said bolt is configured to move to said retracted position in response to activation of said solenoid to move said locking plate to said unlocked position; and wherein said bolt is configured to move to said locked position when said solenoid is not activated to move said locking plate to said locked position.

4. A modular lock assembly as set forth in claim 1 wherein said input device is selected from the group consisting of at least one of a keypad positioned on said mounting plate, a Bluetooth receiver, a radio frequency identification receiver, or a near field communication receiver.

5. A modular lock assembly as set forth in claim 1 wherein said mounting plate has a generally rectangular shape and has an inside surface and an outside surface and extends between a top edge and bottom edge along a pair of side edges.

6. A modular lock assembly as set forth in claim 5 wherein said custodian opening is defined adjacent to said top edge; and said at least one tongue extends from said mounting plate adjacent to said bottom edge.

7. A modular lock assembly as set forth in claim 6 further including a custodian lock received by said custodian opening; wherein said custodian lock includes a key slot and a locking tab being rotatable relative to said mounting plate past said top of said mounting plate for engaging said frame to lock said mounting plate to said frame.

8. A modular lock assembly as set forth in claim 5 wherein said locking plate is coupled with said mounting plate, said locking plate overlies said inside surface of said mounting plate, and wherein said locking plate is linearly moveable past one of said sides in perpendicular relationship to said at least one of said sides toward said locked position.

9. A modular lock assembly as set forth in claim 5 further including a support member overlying said inside surface of mounting plate; a pair of guide fingers having an L-shape extending from said support member and positioned in spaced and aligned relationship with one another and each defining a channel; and wherein said locking plate is received by said channels of said guide fingers and moveable relative to said guide fingers.

10. A modular lock assembly as set forth in claim 9 wherein said locking plate has an upper surface and a lower surface, and wherein a pair of retaining fingers each extend from one of said upper and lower surfaces for engaging one of said guide fingers during movement of said locking plate toward said locked position to limit movement of said locking plate.

11. A locker including:
a frame defining a storage compartment;
a door pivotally connected to said frame and moveable to open and close said storage compartment;
said frame defining an opening adjacent to said storage compartment;
a modular lock assembly removeably received in said opening and configured to be selectively secured to said frame;
said modular lock assembly including a mounting plate removeably disposed in said opening;
at least one tongue extending from said mounting plate and engaging said frame for securing said mounting plate to said frame;
a locking plate moveably connected to said mounting plate and moveable between a locked position engaging said door to prevent said door from opening, and an unlocked position being spaced from said door to allow said door to open;
an electromechanical actuator coupled to said mounting plate and further coupled with said locking plate to automatically provide the movement of said locking plate between said locked position and said unlocked position;
an input device electrically connected to said electromechanical actuator for activating said electromechanical actuator in response to inputs received; and
said mounting plate defining a custodian opening in spaced relationship with said at least one tongue for receiving a custodian lock for locking said mounting plate to said frame.

12. A modular lock assembly as set forth in claim 11 wherein said electromechanical actuator includes a solenoid and a bolt coupled to said solenoid and said locking plate, wherein said bolt is moveable to provide said movement of said locking plate between said locked and unlocked positions, and wherein a biasing member is coupled with said bolt and biases said bolt in an extended bolt position which positions said locking plate in said locked position.

13. A modular lock assembly as set forth in claim 12 wherein said bolt is moveable between said extended position and a retracted position; wherein said bolt is configured to move to said retracted position in response to activation of said solenoid to move said locking plate to said unlocked position; and wherein said bolt is configured to move to said locked position when said solenoid is not activated to move said locking plate to said locked position.

14. A modular lock assembly as set forth in claim 12 wherein said bolt and said locking plate are linearly moveable.

15. A modular lock assembly as set forth in claim 11 wherein said input device is selected from the group consisting of at least one of a keypad positioned on said mounting plate, a Bluetooth receiver, a radio frequency identification receiver, or a near field communication receiver.

16. A modular lock assembly as set forth in claim 11 wherein said mounting plate has a generally rectangular shape and has an inside surface and an outside surface and extends between a top edge and bottom edge along a pair of side edges.

17. A modular lock assembly as set forth in claim 16 wherein said custodian opening is defined adjacent to said top edge; and said at least one tongue extends from said mounting plate adjacent to said bottom edge.

18. A modular lock assembly as set forth in claim 17 further including a custodian lock received by said custodian opening; wherein said custodian lock includes a key slot and a locking tab being rotatable relative to said mounting plate past said top of said mounting plate for engaging said frame to lock said mounting plate to said frame.

19. A modular lock assembly as set forth in claim 16 wherein said locking plate is coupled with said mounting plate, said locking plate overlies said inside surface of said mounting plate, and wherein said locking plate is linearly moveable past one of said sides in perpendicular relationship to said at least one of said sides toward said locked position.
